(19) United States
(12) Patent Application Publication
(10) Pub. No.: US 2020/0232785 A1
(43) Pub. Date: Jul. 23, 2020

(54) SURFACE HEIGHT MEASUREMENT SYSTEM

(71) Applicants: HEWLETT-PACKARD DEVELOPMENT COMPANY, L.P., Spring, TX (US); OREGON STATE UNIVERSITY, Corvallis, OR (US)

(72) Inventors: Dan Mosher, Corvallis, OR (US); Brian Bay, Corvallis, OR (US); David A. Champion, Corvallis, OR (US); James McKinnell, Corvallis, OR (US)

(73) Assignees: HEWLETT-PACKARD DEVELOPMENT COMPANY, L.P., Spring, TX (US); OREGON STATE UNIVERSITY, Corvallis, OR (US)

(21) Appl. No.: 16/486,469

(22) PCT Filed: Apr. 1, 2017
(86) PCT No.: PCT/US2017/025648

§ 371 Date: Aug. 15, 2019

(51) Int. Cl. G01B 11/06; B29C 64/393; G06K 9/00

(52) U.S. Cl. CPC G01B 11/0608; G06K 9/00208; B29C 64/393

(57) ABSTRACT

A first camera and a second camera oriented at different angles and spaced a separation distance to determine surface height measurements. The cameras are focused at a lens focal length to a surface area to record a captured image pair of x-y pixels having common features of the surface area. Correlation of the captured image pair is performed to measure a set of disparity distances between the common features in the captured image pair using a fiducial to assist. The set of disparity distances is converted to a set of z-height measurements with a resolution incorporating the separation distance, the lens focal length, the set of disparity distances, and a calibration error factor.

### BACKGROUND

Quality control, inspection, and diagnostic capabilities are many aspects of modern manufacturing systems and material design. Innovative technologies such as nano-technology, modern metallurgy, three-dimensional (3D) printing, and other new fabrication processes are changing the manufacturing landscape. As these technologies evolve and their processing capabilities expanded, new techniques for analyzing, identifying, detecting, and performing forensic analysis will be helpful in advancing these innovations towards mainstream manufacturing.

### BRIEF DESCRIPTION OF THE DRAWINGS

The disclosure is better understood with respect to the following drawings. The elements of the drawings are not necessarily to scale relative to each other. Rather, emphasis has instead been placed upon illustrating the claimed subject matter. Furthermore, like reference numerals designate corresponding similar parts through the several views. However, for brevity, reference numbers used in latter drawings that are repeated may not always be re-described.

FIG. 1 is a schematic drawing of an example surface height measurement system with dual angled cameras using fiducials and a calibration error factor;

FIG. 2 is a diagram illustrating how height may be determined using the surface height measurement system of FIG. 1 per one example;

FIG. 3 is an illustration of an example three-dimensional (3D) object being created using a multi-layer additive process;

FIG. 4 is an illustration of an example surface height measurement system having multiple light sources with cross-polarization to help identify surface features;

FIG. 5 is a schematic drawing of an example additive 3D printer that incorporates the example surface height measurement system of FIG. 1;

FIG. 6 is a representation of an example user interface illustrating example cross-sectional views of unprocessed build material layers and processed build material layers for an example 3D object;

FIGS. 7A and 7B are flowcharts of example instructions which may be used to operate an example surface height measurement system; and

FIG. 8 is a set of example unprocessed material layers compared to an example computer aided design model of a 3D object to demonstrate an ability of an example surface height measurement system to make predictive analysis of a 3D multilayer build process.

### DETAILED DESCRIPTION

Detecting surface height of seemingly flat or fine surfaces with binocular camera pairs, such as of 3D printing build material layers, is very difficult as the fine surfaces may appear to lack varying surface profiles to allow for matching and correlating the two stereo images. Build material, such as metal powder and sintered surfaces as well as various plastic powders and fused or melt-formed surfaces may appear flat and lack surface contrast. Alternatively, the use of laser scanning metrology is very slow and may take several tens of seconds to complete an analysis of a whole layer of build material. Adding “white light speckle” is often used as a technique to improve image speckle contrast for image correlation to allow for high precision surface roughness height measurements in surface profilometry. However, this white light speckle is often painted, deposited, or otherwise applied to a surface that is to be tested. Nonetheless, if the contrast of surface features within stereo images is poor, image matching machine readable instruction may take a long time to converge on a correlation, if it is even at all possible.

Some surfaces, such as build material powder layers in 3D printing systems, cannot have their surfaces altered or such alternation might cause the 3D printing process to perform incorrectly. Moreover, 3D printing is an additive multilayer process and inspection of a build area is desired to be performed within each layer deposition cycle time of a few seconds with high accuracy, resolution, and speed. The cycle time may repeat over thousands of layers. Various build material recoating parameters, especially layer thickness and uniformity have been found to impact finished 3D object part properties. Further, build material layer thickness, layer uniformity, and build material temperature and packing density can all be expected to impact a particular 3D printing process heat transfer process. One cannot assume that each build material layer is smooth and consistent, particularly when the 3D printer is used in an extended use and high volume production environment. In such a situation, various machine, material, and process parameters may be continually varying and it may be difficult to accurately measure surface height with single vision or binocular stereo vision systems. Various adjustments to increase the resolution in stereo vision systems may unfortunately counteractively affect the overall accuracy and reduce the speed of processing. Accordingly, it is difficult to adjust for one improvement without degrading other aspects of the stereo vision system.

The following disclosure describes a surface height measurement system that incorporates other compensating factors and techniques to keep possible a triad of high accuracy, high resolution, and high speed during surface layer imaging and surface height measurement. Further, the herein described fast and accurate surface height measurement system has particular applicability in 3D multilayer additive printing systems to allow for processing surface height measurements for both unprocessed build material layers and processed build material layers within desired layer cycle times. A ‘cycle time’ is the time it takes to perform a 3D printing operation to spread out a layer of powder, pre-heat the layer, and then selectively solidify portions of the layer. Having both the pre-processed and post-processed surface height details of a multilayer 3D object build allows for diagnostic, inspection, correction, and quality control to occur both in-situ during manufacturing and post manufacturing. More specific detail follows in the detailed description of the drawings which follow.

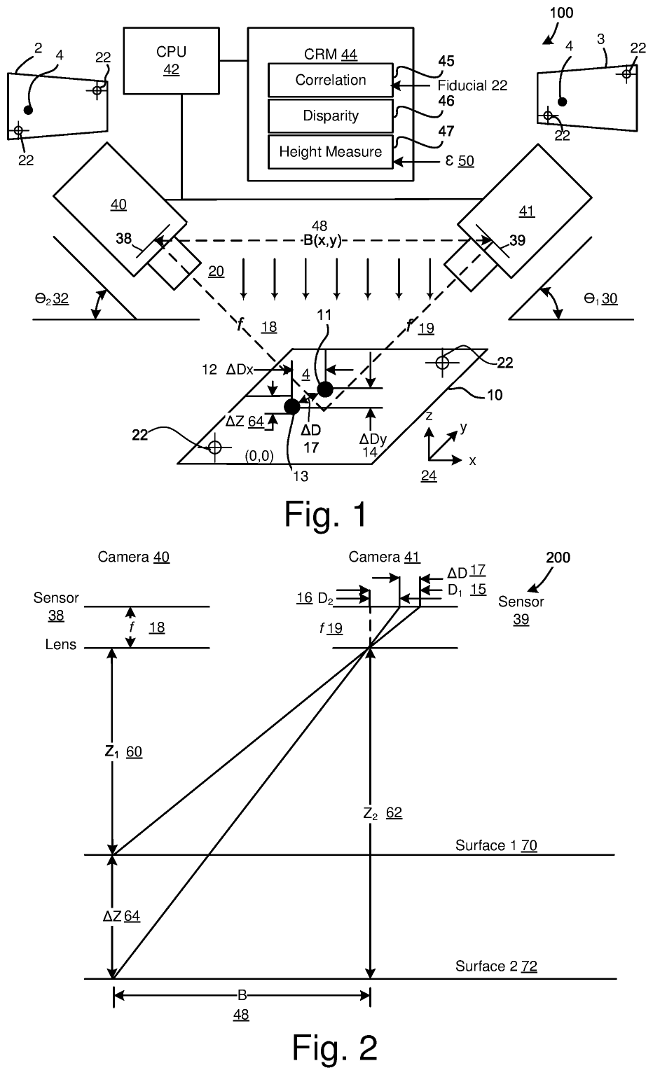

FIG. 1 is a schematic drawing of an example non-binocular surface height measurement system 100 with dual angled stereo cameras, first camera 40 and second camera 41. The system 100 uses a calibration error factor 50 to allow for a realistic assessment of measurement reliability that is paramount to confirming the accuracy of measurement results. Collectively, any surface features 4 present in each of the dual images 2,3 may be referred to herein as common surface features 4. The system 100 also may include a set of fiducials 22 to allow for fast processing of common surface features 4 with flat or fine surfaces by assisting processing of recorded stereo or dual images 2, 3 (also used herein as a captured image pair 2, 3). For ease of description, a rectangular {x, y, z} coordinate system 24 is shown, although other coordinate systems may be used. In this description, the terms “up and down” relate to the z direction, “left and right” to the x direction, and “in and out of the page” to the y-direction. These descriptors are not meant to be limiting and the axis may be oriented differently and other coordinate systems may be used. For this disclosure, the z axis represents a z-height dimension and the x and y axes a plane of the surface area 10. In this example, a common surface feature 4 is viewed as a first surface feature 11 by the first camera 40 and viewed as a second surface feature 13 by the second camera 41 and located a ΔDx 12 and a ΔDy 14 relative disparity distance or a ΔD 17 absolute disparity distance. The surface feature 11, 13 has a z-height of ΔZ 64.

“Disparity distance” can be measured in terms of the number of pixel displacements between a common surface feature 4 imaged in a first image 2 and a second image 3 from the first and second cameras 40, 41. Because a common surface feature 4 may overlap multiple pixels, image processing routines may be used to align, correlate the dual images 2, 3, and determine the measured disparity distance within a sub-pixel accuracy by using interpolation techniques. Due to optical configurations, orientations, errors, and other factors, the dual images 2, 3 may not be the same size, aligned, or of the same geometric shape. An image processing function known as “rectification” may be used to resize and reshape images to make alignment and correlation better. Rectification in this instance may mean correcting an image to match an image sensor geometry but may be more broadly defined as making an image corrected for any expected optical distortions.

To help improve contrast and surface detail of common surface features 4 in dual images 2, 3, the dual cameras 40, 41 are counter-angled respectively at substantially similar opposing angles ⊖₁ 30, ⊖₂ 32 to a x-y plane defined by a surface area 10 under inspection. For instance, the opposing angles may be 45 degrees or more generally between about 55 degrees and 70 degrees for many examples. Lower angles generally allow for greater depth extraction but just up to a point where depending on the height of the surface features 4, shading or shadowing and reflections may occur and the dual images 2, 3 begin to differ making correlation difficult. In other examples, ⊖₁ 30 and ⊖₂ 32 may be oriented at different angles. This example of different angles for the two cameras 40, 41 may be useful when expected deep surface features 4 in a surface area 10 under inspection might cause shading or shadowing in opposing camera views. The first camera 40 and the second camera 41 may be separated by a separation distance B 48 (aka stereo baseline) that is larger than at least one side (or the diameter if circular) of the surface area 10 to increase resolution as explained in how surface height measures are determined below.

Generally, increasing the separation distance B 48 might increase accuracy but does so at the cost of lowering resolution by limiting the closest common surface feature 4 that can be found. Increasing the separation distance B 48 also reduces the percentage of valid disparity distance pixels as the image overlap is less certain due to image sheer such as the key-stoning shown in dual images 2, 3. Another issue with angling the cameras 40, 41 is that of maintaining a consistent focus or depth of field (DOF) over the entire field of view (FOV) of surface area 10. The DOF is dependent on the camera, lens, and geometry of the configured system. The DOF may be increased by using a larger lens f-number, decreasing the focal length of the lens, using an image sensor with a larger circle of confusion, and increasing the distance of the camera from the surface area 10. Minimizing the opposing angles also increases the possibility of greater occlusion and more variation in appearance of the common surface features 4 between first and second cameras 40, 41.

Rectification may be used to correct geometric distortion such as image shear but due to the white noise nature of material build layers, it is difficult to align the images or take a long time for machine readable instruction to find a solution. To help speed rectification and alignment, a set of fiducials 22 may be added to the images 2, 3 or their location provided to a correlation routine 45 to assist in fast alignment of the dual images 2, 3 due to image shift, magnification errors, rotation errors, camera misalignment, and image shear. For example, a fiducial 22 may be added to the dual images 2, 3 by using a light source projected onto the surface area 10, such as a laser pointer or another projection device. In other examples, a fiducial 22 may be printed on the surface area 10. A fiducial 22 may be leveraged as a tracking mechanism to reliably determine useful starting parameters for correlation to be performed. Once the starting parameters have been determined for a region containing a fiducial, subsequent correlation of the dual images 2, 3 may be performed using the texture of build material layers as a tracking mechanism. Adding the set of fiducials 22 may also improve focusing thereby improving resolution of common surface features 4. The addition of a set of fiducials 22 thus assists in faster rectification and correlation of dual images 2, 3 while also assisting in improving accuracy and resolution. The set of fiducials may also be used to assist the disparity measurement process faster and more reliable by providing a stable and consistent starting point from which the full disparity measurement process can proceed. Further, improving the lighting of surface area 10 may decrease the probability of occlusion and variation in common surface features 4 further enhancing speed, accuracy, and resolution.

For instance, the two cameras 40, 41 may be oriented along the x or y axis of a rectangle surface area 10, magnified, and focused at a lens focal length f 18, 19 to align as much of the surface area 10 within the camera sensors 38, 39. If the camera sensor 38, 39 is a 4:3 aspect ratio sensor, that is wider in the horizontal axis than the vertical axis, the camera's sensors 38, 39 may be oriented and aligned along the shorter of the x or y axis of rectangular surface area 10 to maximize sensor coverage of the longer x or y axis. Increasing pixel coverage in the dual images 2, 3 further helps increasing resolution. The focal lengths f 18, 19 may be different for each camera, particularly if at different opposing angles 30, 32 or there are differences in the two-camera optics. Generally, however, the lens focal length f 18, 19 may be substantially the same and configured to maximize image sensor pixel coverage to make as full use of the camera's sensors 38, 39 as possible. In most examples, the lens focal length f 18, 19 and the focus may both be set at the center of surface area 10.

The surface area 10 may be illuminated by a light source 20 to reduce shadows, light speckle, and undesired reflections and thereby enhance image texture of the surface area 10. In one example, the light source 20 may be natural sunlight, ambient light, artificial light, or combinations thereof. In other examples, the light source 20 is specifically designed and configured for the type of surface area 10 under inspection to provide light at the proper angles, frequency(cies), polarization, and intensity used to resolve the common surface features 4. The light source 20 may have its intensity, polarization, and color controlled by a processor, CPU 42, to provide different illumination levels depending on the surface area 10 being measured, for instance a higher intensity for unprocessed build material layers and a lower intensity for processed build material layers which may have greater reflections due to the sintered or formed build material having more reflective surfaces. In one example, the light source may be monochromatic to reduce color aberrations in the camera lenses and thereby increase accuracy of the z-measurement readings. In other examples, the light source 20 may have multiple complementary different polarized light sources, programmable or fixed, with complementary different polarizing filters on the first and second camera 40, 41 lens to reduce reflections and enhance the surface texture (see FIG. 4).

The first and second cameras 40, 41 may be communicatively coupled to a processor, such as CPU 42, to record the image sensor 38, 39 contents of each camera 40, 41 as a captured image pair 2, 3. In other examples, the first and second cameras 40, 41 may have the captured image pair 2,3 stored in a memory accessible by CPU 42 to read and process. CPU 42 may be one or multiple processors having one or multiple cores and of one or multiple processor architectures such as x86™, x64™, ARM™, PowerPC™, and the like. The CPU 42 is further coupled to a non-transitory computer readable medium (CRM) 44 that contains sets of instructions organized as modules or routines that are readable and executable by the CPU 42. A computer readable medium (CRM) 44 allows for storage of sets of data structures and machine readable instructions (e.g. software, firmware, logic) representing or utilized by any of the methodologies or functions described herein. The instructions may also reside, completely or at least partially, with the static memory, the main memory, and/or within the processor CPU 42 during execution by the processor. The main memory and the processor memory may also constitute computer readable medium 44. The term “computer readable medium” 44 may include single medium or multiple media (centralized or distributed) that store the instructions or data structures. CRM 44 may be implemented to include, but not limited to, solid state, optical, and magnetic media whether volatile or non-volatile. Such examples include, semiconductor memory devices (e.g. Erasable Programmable Read-Only Memory (EPROM), Electrically Erasable Programmable Read-Only Memory (EEPROM), and flash memory devices), magnetic discs such as internal hard drives and removable disks, magneto-optical disks, and CD-ROM (Compact Disc Read-Only Memory) and DVD (Digital Versatile Disc) disks.

The CRM 44 may include 1) a correlation module 45 that is used to correlate the dual images 2, 3 recorded from sensors 38, 39 in cameras 40, 41 using a fiducial 22 to assist; 2) a disparity module 46 to create a set of disparity distances 17 from the correlated images; and 3) a height measure module 47 to create a set of z-height measurements ΔZ 64 from the set of disparity distances 17 with a calibrated resolution for the surface area 10 by incorporating the set of disparity distances 17, the camera distance B 48, the focal lengths 18, 19, and a calibration error factor ε 50.

To assist in determining rectification and an origin of surface area 10, a set of fiducials 22 may be used. In one example, the set of fiducials is provided as a location to the correlation routine 45 to help rectify, align, and speed up the correlation search. For instance, an origin and a set of fixed pixel locations used in rectification from a previous layer cycle may be provided and used in a current layer cycle as a set of fiducials 22. In other examples, the set of fiducials 22 may located in one of many ways and read by cameras 40, 41 and the position(s) of the set of fiducials 22 used by the correlation routine 45 to align and speed up the correlation of the dual mages 2, 3 from the camera sensors 38,39. In one example, the set of fiducials 22 may be located at a local minimum of a calibrated surface area 10. In another example, a specially prepared surface target is placed or projected into the surface area 10 and an image 2, 3 taken by each camera 40, 41. The dual images 2, 3 may be quickly rectified, aligned, and correlated using the surface target fiducials 22.

A disparity routine 46 with sub-pixel interpolation can be used to process the image pair 2, 3 to create a set of disparity distances ΔD 17. For instance, a first surface height feature 11 on the surface area 10 for a first image sensor 38 is located a distance ΔDx 12 and a distance ΔDy 14 from a correlated second surface height feature 12 on the second image sensor 39 to create a disparity distance ΔD17 equal to ((ΔDx)²+(ΔDy)²)^{1/2} and using sub-pixel interpolation to increase resolution. This disparity distance calculation is done for each surface height feature detected between the two image pairs 2, 3. This creates the set of disparity distances ΔD 17. Knowing the disparity distances for each feature located at an (x, y) sub-pixel position, the z-height measurement ΔZ 64 may be performed by the height measurement routine 47 using a calibration error factor ε50.

FIG. 2 is a diagram 200 illustrating how z-height ΔZ 64 may be determined using the surface height measurement system 100 of FIG. 1 with a measured set of disparity distances ΔD 17. Assume the lens focal length f 18, 19 of each camera 40, 41 is the same. Z₁ 60 is the perpendicular distance in meters from first camera 40 to a common surface height target at a hypothetical surface 1 70 above/below surface area 10 and Z₂ 62 is the perpendicular distance in meters from second camera 41 to the same common surface height target at a hypothetical surface 2 72 above/below on surface area 10. The lens focal length f 18, 19 are the respective focal lengths in pixels for each camera 40, 41. B 48 is a baseline distance between the first and second cameras 40, 41. D₁ 15 is the distance in pixels from an origin (such as a fiducial 22 or other determined origin location) to the common height target for the first camera 40 and D₂ 16 is the distance in pixels from the origin to the common height target for the second camera 41. ΔD 17 (D₁-D₂) is the disparity distance in pixels between the common surface features 4 in each of the image sensors 38, 39 noting the common height target.

By triangulation the difference in any two z-height measurements may be written as:

$$Δ Z = {Z}_{2} - {Z}_{1} = \frac{fB}{{D}_{2}} - \frac{fB}{{D}_{1}} = fB ( \frac{Δ D}{{D}_{1} {D}_{22}} )$$

The z-height measurement resolution may be obtained by minimizing the above result:

$$min ( Δ Z ) = min ( fB ( \frac{Δ D}{{D}_{1} {D}_{2}} ) ) = fB ( \frac{min ( Δ D )}{{D}^{2}} )$$

where min(ΔD) is the sub-pixel interpolation resolution applied to measure disparity distances 17 between common surface features 4 in the dual images 2, 3 of the camera sensors 38, 39.

However, min(ΔZ) is just an ideal achievable z-height resolution and due to various calibration factors and possible error sources, this z-height resolution is to be adjusted. In one example, the adjustment may be a single calibration error factor ε 50 or it may be determined from a calibration procedure to be set on a pixel by pixel basis, a regional area basis, or formula based as a function of one or both the x and y pixel (or sub-pixel) locations of the set of disparity distances. Accordingly, the calibration error factor ε 50 may be at least one of a uniform error factor, a pixel by pixel error factor and a formulated error factor based on pixel location with the surface area. Including a calibration error factor ε 50 into the z-height measurement resolution allows for the z-height measurement ΔZ 64 to be realistically accurate.

The z-height measurement resolution min(ΔZ) is converted to an error approximation by adding a projected calibration error factor ε 50 (in pixels) to the sub-pixel interpolation, which can be written as:

$$min ( Δ Z ) = fB ( \frac{min ( Δ D )}{{D}^{2}} ) \to {Z}_{e} = fB ( \frac{min ( Δ D ) + ϵ}{{D}_{2}} ) = {Z}^{2} ( \frac{min ( Δ D ) + ϵ}{fB} )$$

The z-height measurement may then be reported in terms of:

z−height=mod((ΔZ+Surface 2 height), Zₑ)

where surface 2 height may be a local minimum or origin value of surface area 10.

The range of acceptable operating angles for the dual cameras 40, 41 that reduces the Ze height measurement error may be derived from the equation above. Increasing B reduces the Zₑ error but as noted previously, B can only be increased so much before other errors come into play. The depth of field (DOF) requirements to sufficiently focus the entire field of view (FOV) of the surface area 10 may surpass the capabilities of many camera systems long before the operating camera angles ⊖ 30, 32 ever approach zero. As noted earlier, occlusion and shading errors may also come into play. The DOF for a camera-lens combination may be calculated using the following equation:

$$DOF = \frac{2 {Ncf}^{2} {s}^{2}}{{f}^{4}}$$

where N is the lens f-number, c is the circle of confusion of the imaging sensor (mm), f is the focal length of the lens (mm) and s is the distance at which the camera is focused (mm). The DOF required to sufficiently focus a given horizontal FOV (HFOV) may be derived as a function of the camera operating angle as:

DOF=HFOVcos(θ_{camera})

where HFOV is the shortest dimension of the surface area 10 when the longest dimension is used to fill one dimension of the imaging sensor. Rearranging the above equation to solve for the minimum operating camera angle to provide the lowest Zₑ height measurement error based on camera-lens parameters and geometry of the system gives the following result:

$${θ}_{camera , min} = {cos}^{- 1} ( \frac{DOF}{HFOV} ) = {cos}^{- 1} ( \frac{2 {Ncf}^{2} {s}^{2}}{{f}^{4}} / HFOV )$$

Consequently, the camera angle ⊖ 30, 32 for the dual cameras 40, 41 may be set between about ⊖_{camera,min} and about 70 degrees to 90 degrees yet as close as possible towards ⊖_{camera,min} to increase the z-height measurement accuracy and resolution.

For instance, if the field of view of the surface area 10 is a 6-inch (“) by 8-inch (”) area, an example commercial 12 Mega-pixel dual camera system may be spaced with a separation distance B 48 greater than at least 6 inches and oriented, aligned, zoomed, and focused to resolve 48 um/pixel over the 8″×6″ surface area 10. The camera-lens has an N lens f-number 0f 16, a circle of confusion c of 0.011 mm, a focal length f of 35 mm, and an s distance at which the camera is focused of 540 mm. This provides a depth of field of:

DOF=2(16)(0.011 mm)(35 mm)²(540 mm²)/(35 mm)⁴=84.3 mm

and a minimum camera operating angle of:

$${θ}_{camra , min} = {cos}^{- 1} ( \frac{84.3 mm}{25.4 mm \text{/} in * 6 in} ) = 56.4 °$$

An empirical system of the above parameters has been able to resolve z-height measurements with at least a 6.5-micron resolution.

If a smaller field of view is used, such as with a 2″×2.5″ surface area, the current example commercial 12 Mega-pixel dual camera system may be spaced with a separation distance B greater than 2″ and oriented, aligned, zoomed and focused to resolve 15 um/pixel over the smaller surface area 10 and an empirical system with the above parameters has been able to resolve z-height measurements with at least a 1.4-micron resolution. Both of these empirical systems can perform a set of z-measurements of surface area 10 within 1 second.

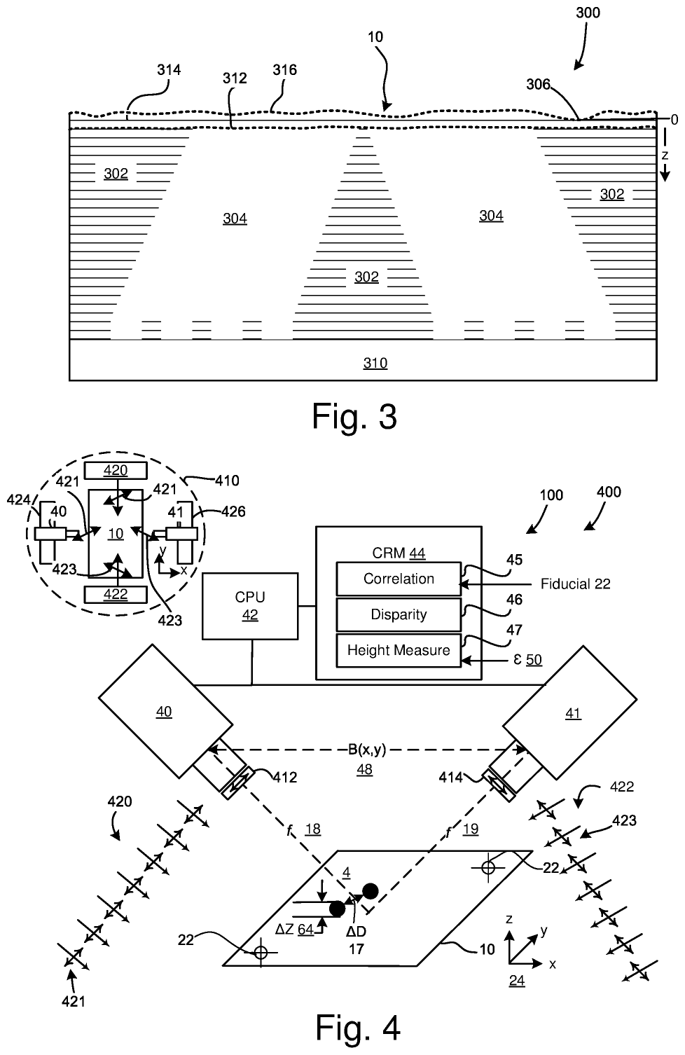

FIG. 3 is an illustration 300 of an example three-dimensional (3D) object 304 being created using a multi-layer additive process with multiple layers 314 of build material 302. The multiple layers 314 of build material 302 and the 3D object 304 is formed and processed on a build platform 310 which is movable in the z axis downward as each layer 314 is deposited, spread, or otherwise laid down and dispersed on top of previous layers of build material 302 and 3D object 304. In some examples, a local minimum 306 is processed and returned by the correlation routine 45. To help speed up locating a local origin 306, a set of fiducials 22 may be submitted to and/or processed by correlation routine 45 using captured image pairs 2,3 with the fiducials 22 from the camera sensors 38, 39. For instance, in one example, the fiducial 22 may an image projected onto the build area 10 (such as by a laser pointer or other projection system) and imaged by each of first and second cameras 40, 41. In another example, the fiducial 22 may be a deposited material such as a pigmented fusing agent in an area generally away from 3D object 304 while it is being built. In yet other examples, the fiducial 22 may be a separate 3D object also located away from the 3D object 304. Use of a projected fiducial 22 may allow for measurement of layers at any time in a 3D printing process. Use of printed fiducial 22 may limit the measurement of layers to happen after a printing pass of the pigmented fusing agent has occurred for an unprocessed material build layer. In some examples, a local minimum 306 of a previous layer may be used as a fiducial 22 passed to the correlation routine of a next layer to be used as a starting point and thus minimize the time required to find the local minimum 306 for the next layer as often the local minimum will be defined by recoater spreading errors that are repeatable over multiple layers.

The 3D printing process may be a multilayer process of build material 302 that is coated with a coalescing agent (not shown) to absorb light energy to melt the build material 302 where the 3D object 304 is to be formed. In other examples, the 3D printing process may include build material of various metal powders that may be sintered with an energy source such as a directed laser or other electromagnetic source, including heated irons. In most examples, the build platform 310 may be movable to allow the 3D object to drop down and allow a new layer 314 of build material 302 to be deposited on top of the previous processed build material surface 312 and create a new unprocessed build material surface 316. The surface height measurement system 100 may be used to determine both the z-height measurements ΔZ 64 of the processed build material surface 312 before it is moved down and the z-height measurement ΔZ 64 of the unprocessed build material surface 316 after it is laid down. The 3D printing system may provide a trigger signal or a trigger signal may be determined by monitoring the 3D build process components.

FIG. 4 is an illustration 400 of an example surface height measurement system 100 having dual light sources 420, 422 with cross-polarization to help differentiate common surface features 4 on surface area 10. Inset 410 is a top view of the surface height measurement system 100 showing the first and second cameras 40, 41 as being oriented orthogonal to the dual light sources 420, 422. A first light source 420 has its light polarized in a first direction 421 and correspondingly, first camera 40 has a polarization filter 412 oriented in first direction 421 to receive light from first light source 420 reflected from the surface area 10 and substantially block light from second source 422. The second light source 422 has its light polarized in a substantially orthogonal second direction 423 to first direction 421 and correspondingly the second camera 41 has a second polarization filter 414 oriented in second direction 423 to receive light from second source 422 reflected from the surface area 10 and substantially block light from first source 420. By having a cross-polarization light source oriented perpendicular to the axis of the first and second cameras 40, 41, the surface texture of surface area 10 may be enhanced by reducing reflections, light speckle, and shadows making common surface features 4 more distinct and allowing a correlation routine to operate faster. The first and second light sources 420, 422 may be incandescent, LED, fluorescent, halogen, and the like and may be of an area flood design to allow for uniform distribution of the light energy across the surface area 10.

In another example, additional third and fourth light sources 424, 426 may be oriented along the axis of the first and second cameras 40, 41 to provide further illumination and prevent shadows. The polarization of the third light source 424 under first camera 40 may have the same polarization orientation as the polarization filter 412 to just accept reflected light from surface area 10 and block direct and reflected light from the fourth light source 426 under second camera 41. The fourth light source 426 under second camera 41 may have its polarization oriented to have the same polarization as the second polarization filter 414 so just reflected light from surface area 10 is directed to second camera 41 and to block light from the third light source 424 beneath first camera 40.

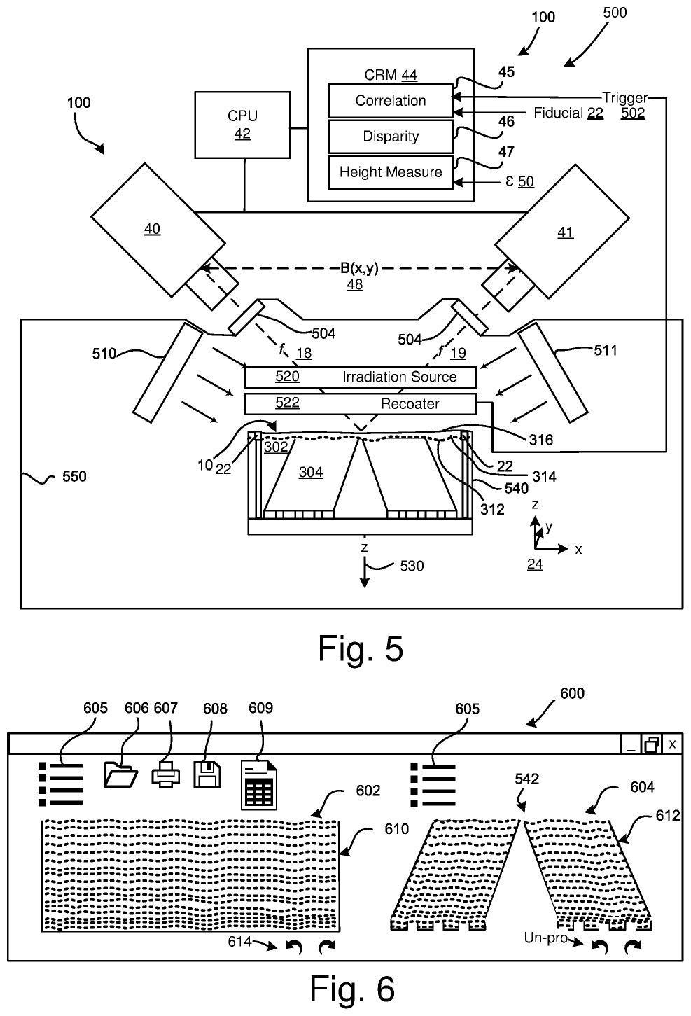

FIG. 5 is a schematic drawing of an example additive 3D printer 500 that incorporates the example surface height measurement system 100 of FIG. 1. In this example, an enclosure 550 encompasses a build bed 540 for building a 3D object 304. The enclosure may include a set of view ports 504 to allow the cameras to exist outside of the enclosure 550 to prevent vapors, particles, and other contaminants from attaching to the lenses of first and second cameras 40, 41. The view ports 504 may include I/R, UV, polarization, or other filters to help prevent damage to the dual cameras 40, 41 and to help in enhancing surface texture of the surface area 10. In some examples, the first and second cameras 40, 41 may be encased within the enclosure 550.

A recoater 522 in this example moves in and out of the page (in the y-axis direction) to place down and distribute a layer of build material 314 onto a surface area 10. In some examples, the recoater 522 is a spreading bar and in other examples recoater 522 may be a roller. Recoater 522 may also include a hopper (not shown) to hold build material. An irradiation source 520 may be used to heat the build material. The irradiation source 520 may be stationary or oriented and configured to move in either the x, left and right, or y, in and out of the page, directions. The 3D printer 500 may also include a coalescing agent spreading system (not shown) to coat areas of the build material 302 to allow for better absorption of energy from the irradiation source 520. Irradiation source 520 may be a laser system in some 3D printing systems used for sintering build material such as metal powder. In other examples, the irradiation source 520 may be an infra-red (I/R), ultraviolet, or other electromagnetic source that is absorbed by the coalescing agents placed on the build material to allow for selective heating.

The build bed 540 is moved in a downward direction 530 before each layer of build material 302 is deposited and spread. The build bed 540 is illuminated with a first light source 510 and a second light source 511 in this example to provide good image texture of the surface area 10 for the first camera 40 and the second camera 41 to capture dual images 2, 3 of the unprocessed build material layer 314. The first light source 510 and the second light source 511 may be cross-polarized and appropriate polarization filters used with the first and second cameras 40, 41 as explained in FIG. 4. Once the build material layer 314 is placed on surface area 10 and spread a first trigger signal 502 is received from the 3D print to create a first set of z-height measurements ΔZ 64.

The build material layer 314 surface, whether a metal or plastic powder, may be optically like white light speckle which is the basis of high precision height measurement of stereo dual images 2, 3. However, once processed, it may not be optically like white light speckle. Because many techniques for correlation may take an unknown time to correlate stereo dual images 2, 3, there may be a long and uncertain time to execute the correlation routine 45. To ensure a quick correlation of the stereo dual images 2, 3, a set of fiducials 22 (including just one in the set) may be projected, deposited, or formed on the build material layer 314 on surface area 10 to assist the correlation routine 45, the disparity routine 46, and the height measurement routine 47 to match and correlate the dual images 2, 3, determine disparity distances, and calculate z-height measurements ΔZ 64 in under about 1 second. For example, the set of fiducials 22 may be leveraged as a tracking mechanism to reliably determine starting parameters for correlation routine 45. Once starting parameters have been determined for a region containing a fiducial 22, subsequent correlation of the dual images 2, 2 may be performed using the texture of the build material layer 314 surface as a tracking mechanism.

In this illustrated example, the fiducials 22 are additional build objects in the build bed 540 that are formed away from the desired 3D build object. In this example, after the build material layer 314 is laid down and spread, a special dyed coalescing agent is used to optically mark the fiducials 22 where they are to be located. In some examples, the coalescing agent used for a fiducial 22 may be designed to not absorb the energy from the irradiation source 520 but in other examples it may absorb the energy to form a solid piece that is less susceptible to errors caused by spreading of the next build material layer 314.

After a z-height measurement ΔZ 64 is taken of the build material layer 314, the irradiation source 520 is moved across the surface area 10 to selectively scienter, fused, melt, or bind the appropriate build material for the particular 3D printer to form a layer of 3D object 304. After irradiation of the build material layer 314 with the energy from irradiation source 520, a second trigger signal 502 is generated or received from the 3D printer to create a second set of z-height measurements ΔZ 64 for the processed build material layer 312. Accordingly, the height measurement system 100 captures both an unprocessed build material surface 316 set of z-height measurements ΔZ 64 and a processed build material layer surface 312 set of z-height measurements ΔZ 64. Having both the unprocessed and processed z-height measurements allows for valuable information to be analyzed, characterized, compared, and monitored during and after a 3D object 304 is built.

For example, FIG. 6 is a representation of an example user interface 600 illustrating example cross-sectional views of unprocessed build material layers 610 and processed build material layers 612 of an example 3D object 304. For instance, a user may use pull-down menus 605 to select the type of image to view for the unprocessed layer images 602 and processed layer images 604. The types of images may be 3D views, 2D cross-sectional views as shown, combined images with the original 3D object model, and more. A user may select from an open file icon 606, a print icon 607, a save icon 608, and a file conversion (such as Excel™ or PDF formats). If a cross-section view is shown, the user may use the forward and back icons 614 to move through the un-shown dimension. For instance, an x-axis and z-axis view may be shown and the user can scan forward and backward in the y-axis direction. In one example, the unprocessed and processed build layers 610, 612 shown can be linked such that scanning through one of the images 602, 604 is done automatically in sync with the other image to be able to see how changes in the various unprocessed layers 610 affect the processed layers 612. While 2D cross-sectional images 602, 604 are shown, other options may be to show 3D topology maps of unprocessed layer images 620 and processed layer images 604.

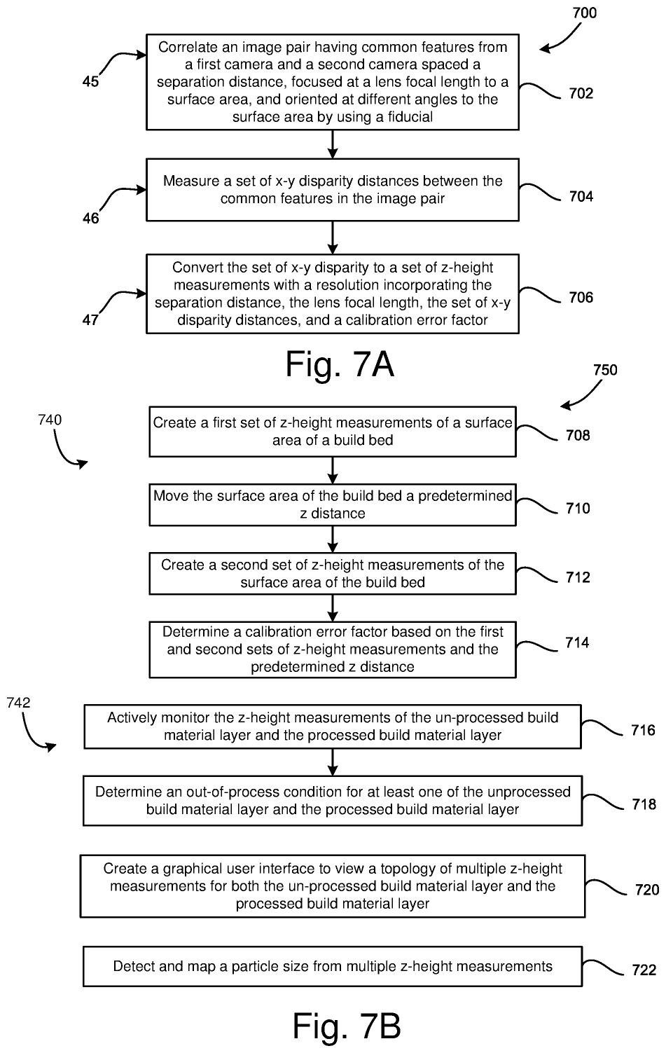

FIGS. 7A and 7B are flowcharts 700, 750 of example instructions which may be used to operate an example surface height measurement system 100. In FIG. 7A a correlation routine 45 may include instructions 702 to correlate an image pair 2,3 from a first camera 40 and a second camera 41 spaced a separation distance B 48, focused at a lens focal length 18, 19 to a surface area 10, and oriented at different angles 30, 32 to the surface area 10 by using a fiducial 22. A disparity routine 46 may include instructions 704 to measure a set of x-y disparity distances ΔD 17 between common features 4 in the image pair. In one example, sub-pixel interpolation may be used to measure a set of x-y disparity distances ΔD 17 between common surface features 4 in the image pair 2, 3. Many different methods of sub-pixel interpolation and disparity distance measurement exist. A height measure routine 47 may include instructions 706 to convert the set of x-y disparity distances ΔD 17 to a set of z-height measurements ΔZ 64 with a resolution incorporating the separation distance B 48, the lens focal length 18, 19, the set of x-y disparity distances ΔD 17, and a calibration error factor ε50.

FIG. 7B includes additional instructions 750 that may be combined with instructions 700 to provide additional functionality the example surface height measurement system 100. For example, calibration instructions 740 may be used to determine a calibration error factor ε 50. Instructions 708 are used to create a first set of z-height measurements ΔZ 64 of a surface area 10 of a build bed 540. Instructions 710 are used to move the surface area 10 of the build bed 540 a predetermined z distance 530, which may be either up or down. Instructions 712 are used to create a second set of z-height measurements ΔZ 64 of the surface area 10 of the build bed 540. The instructions 714 are used to determine a calibration error factor ε 50 based on the first and second sets of z-height measurements ΔZ 64 and the predetermined z distance 530 using statistical analysis of predetermined z distance 530 with respect to the difference between the first and second sets of z-height measurements ΔZ 64.

For example, a 3D printer 500 may have an accurate stepper motor system used to move the build bed 540. By moving the build bed by a predetermined z distance 530, a set of calibration differences between the first and second sets of z-height measurements ΔZ 64 can be compared to the predetermined z height over the surface area 10 and a mean or medium value may be used for at least part the calibration error factor ε 50. By using this approach, any calibration errors caused by the vision system itself, such as with optical alignment, optical distortions, focusing, magnification, rectification, etc. can be incorporated into a single value. However, if the standard deviation of the set of calibration differences exceeds a predetermined threshold, the calibration error factor ε 50 may be a multi-factor calibration error factor ε 50 such as a set of pixel by pixel calibration error factors ε 50, a sub-region based set of calibration error factors ε 50, or a formulated error factor (such as by determined by regression analysis of the set of calibration differences) based on pixel locations within the surface area 10. In some examples, multiple execution of calibration instructions 740 may be performed using multiple pre-determined z distances 530 to further incorporate the build bed 540 positioning within the calibration of the height measurement system 100.

For example, the 3D printer 500 may include a build bed 540 with the surface area 10 and movable in a z axis and the CRM 44 may include instructions determine the calibration error factor ε 50 and its type, whether a single uniform error factor, a pixel-by-pixel error factor, or a formulated error factor based on pixel location within the surface area 10. For instance, the instructions may create a first set of z-height measurements ΔZ 64 of the surface area 10 and then move the build bed 540 by a predetermined z distance. The instructions then may create a second set of z-height measurements ΔZ 64 of the surface area 10 and then determine a set of differences over the surface area 10 between the first and second sets of z-height measurements ΔZ 64. The instructions can then compare the predetermined z distance to the set of differences over the surface area 10; and determine the calibration error factor ε 50 be at least one of a uniform error factor, a pixel by pixel error factor, and a formulated error factor based on pixel location within the surface area based on statistical analysis of the distribution of any error and its variation over the surface area 10.

In another example, a set of monitoring instructions 742 may be used to incorporate the surface measurement system 100 into the 3D build process to actively monitor, diagnose, correct, or alter the process flow of the 3D build process during creation of a 3D object 304. For instance, instructions 716 are used to actively monitor the z-height measurements ΔD 64 of both the unprocessed build material 316 and the processed build material layer 312. Instructions 718 then determine an out-of-process condition for at least one of the unprocessed build material layer 316 and the processed build material layer 312. The instructions 718 may then alter the build session when the out-of-process condition is outside a predetermined threshold to correct for any diagnosed issues, such as pausing or terminating a build session, altering the amount of energy applied to the unprocessed build material 316, re-applying a new layer of unprocessed build material 314, alerting an operator, etc.

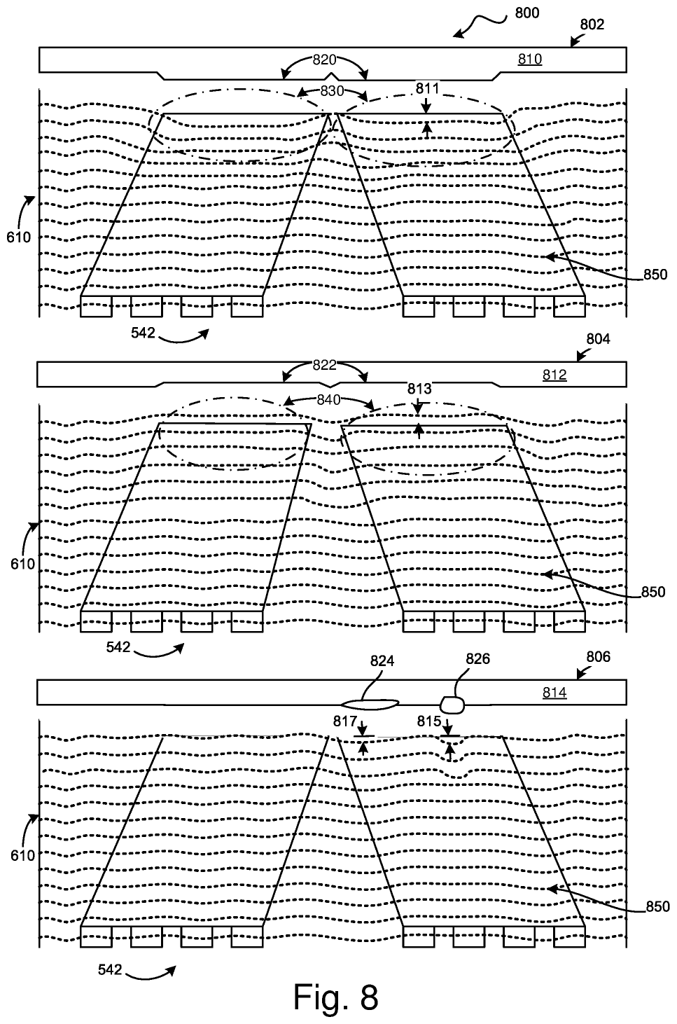

For instance, over time the recoater 522 may have a spreader bar or roller with an elastomeric material that expands in areas of heat contact with the 3D object 304 or contracts based on pressure differences between any unprocessed build material 314 and solid areas of processed build material 314 (see FIG. 8 for examples). Also, some build materials or contaminants may stick, bind, or otherwise adhere to a recoater 522 causing uneven spreading, gouges, or other spreading errors. For example, based off a set of z-height measurements ΔZ 64, it may be determined that there is no material powder over a feature of 3D object 304 that is to be solidified. One corrective action may be to apply a new layer of unprocessed build material 314. Another corrective action may be to not apply energy to the area of missing material powder to prevent reheating portions of 3D object 304. In another example, if residual stress is causing a portion of the 3D object 304 to rise out of the plane of surface area 10, a lower energy or no energy may be applied in that area to help manage stress within the 3D object 304.

If a 3D object build includes thousands of layers, it may be best to either alert an operator of the out-of-process condition, log it for later inspection, or simply stop the 3D build process to allow the out-of-process condition to be corrected or the 3D build process restarted. In some examples, such as detecting that the spread layer has an out-of-process condition due to recoater 522 heating, the instructions may allow the recoater 522 to cool and then re-apply a new powder layer, take a set of z-height measurements ΔZ 64, and confirm that the heating issue has been resolved. If the heating issue re-occurs, the speed of the building of the 3D object 304 may be slowed to allow for natural cooling to occur for the recoater 522, or a fan or other active cooling system for the recoater 522 or the build bed 540 may be activated. If it is determined based on the z-height measurements ΔZ 64 that the recoater 522 is simply wearing out, the system may pause the 3D build and alert the operator to change out and replace the recoater 522.

User interface Instructions 720 may be included to create a graphical user interface 600, such as illustrated in FIG. 6, to allow an operator to view a topology of multiple z-height measurements ΔZ 64 for both the unprocessed build material layer 316 and the processed build material layer 312. The topology shown may be 2D cross-sections, 3D topo maps, with or without superposition of a computer aided design (CAD) model of the 3D object 304. Various options may be included to allow for synchronizing the viewing of the unprocessed and processed build material layers 316, 312. The graphical user interface 600 may be interactive and ongoing with a 3D build or it may be executed after a 3D build by saving and retrieving historical 3D build datafiles.

In other examples, diagnostic instructions 722 may be included to detect and map anomalies during a 3D build such as detecting and mapping a particle size from multiple z-height measurements ΔZ 64 over several layers. The particles may be present in one or both the unprocessed and the processed build material layer images depending upon their source or creation and various process parameters.

FIG. 8 is a set 800 of example unprocessed material layers 810 compared to an example CAD model 850 of a 3D object 304 to demonstrate an ability of an example surface height measurement system to make predictive analysis of a 3D multilayer build process. In these examples, the recoater 522 is a spreader bar with an elastomeric material. In first example 802, a first spreader bar 810 exhibits regions of expansion 820 where heat from the 3D object during the 3D build process is causing the elastomeric material to expand. This expansion causes the unprocessed build material layers 610 to be less in the regions of expansion 830 resulting in a 3D object 304 having less than its predicted height by a first spreading error 811.

In second example 804, a second spreader bar 812 exhibits contraction where the elastomeric member has compressed regions 822 due to the different forces from the unprocessed build material layer and the processed built material layers as shown in regions 640. This compression of the spreader bar causes more build material to be deposited than expected by the example CAD model 850 as shown by second spreading error 813.

In third example 806, the elastomeric material of a third spreader bar 814 is not compressed or expanded but instead, there are clumps 824, 826 of build material or contaminants that are sticking or otherwise adhering to the third spreader bar 814. These clumps 824, 826 depending on their size and location may cause the 3D object 304 being built to have areas that are out-of-process limits such as shown with shallow dip 817 and a larger gouge 815. As the clumps 824, 826 may be on the spreading bar 814 during one or a few layers, unless the layer monitoring of the unprocessed and process build material layers is done and examined, these types of defects may remain hidden with a fabricated 3D object. In some examples, the clumps 824, 826 may be measured based on the height of the shallow dip 817 and larger gouge 815. For instance, the shallow dip may be determined to be non-significant and the occurrence simply logged and the processed continued. However, the larger gouge 815 may be determined to be significant enough that a structural defect may be introduced into the part. In this situation, the 3D build process may be stopped and an operator alerted to clean and/or replace the spreader bar 814. In some examples, the 3D printer may include a service station where the spreader bar 814 may be positioned and the blade cleaned and serviced by the service station.

In another example, the performance of a spreader bar may be examined in a 3D printer servicing operation to determine if it should be replaced. In this example, a layer of unprocessed build material is distributed on a surface area 10 and a set of z-height measurements ΔZ 64 taken. Statistical analysis of the z-height measurements ΔZ 64 may be done to ensure that the mean and standard deviation of the z-height measurements ΔZ 64 fall within a predetermined acceptable range. If due to wear, contamination, aging, warping, or other mechanical changes, the spreader bar is found to not meet the predetermined acceptable range, it may be replaced or repaired.

While the claimed subject matter has been particularly shown and described with reference to the foregoing examples, those skilled in the art will understand that many variations may be made therein without departing from the intended scope of subject matter in the following claims. This description should be understood to include all novel and non-obvious combinations of elements described herein, and claims may be presented in this or a later application to any novel and non-obvious combination of these elements. The foregoing examples are illustrative, and no single feature or element is to be used in all possible combinations that may be claimed in this or a later application. Where the claims recite “a” or “a first” element of the equivalent thereof, such claims should be understood to include incorporation of one or many such elements, neither requiring nor excluding two or more such elements.

What is claimed is:

1. A vision system to determine a set of surface height measurements, comprising:
a first camera and a second camera oriented at different angles and spaced a separation distance and focused at a lens focal length to a surface area to record a captured image pair of x-y pixels having common features of the surface area; and
a processor to receive the image pair, the processor to execute instructions from a computer readable medium, the instructions to:
measure a set of disparity distances between the common features in the captured image pair using a fiducial to assist correlation; and
convert the set of disparity distances to a set of z-height measurements with a resolution incorporating the separation distance, the lens focal length, the set of disparity distances, and a calibration error factor.

2. The vision system of claim 1, wherein the first and second camera have complementary different oriented polarization filters and the vision system further comprises an illumination source including multiple complimentary different oriented polarized light sources positioned around the surface area to enhance image texture of the surface area by reducing shadows, light speckle, and undesired reflections in the captured image pair.

3. The vision system of claim 2, further comprising instructions to allow the processor to control at least one of the intensity, polarization, and the color of the illumination source.

4. The vision system of claim 1, wherein the calibration error factor is at least one of a uniform error factor, a pixel by pixel error factor, and a formulated error factor based on pixel location within the surface area.

5. A 3D printer with a vision system to determine a set of surface height measurements, comprising:
a first camera and a second camera each oriented at different angles and spaced a separation distance and focused at a lens focal length to a surface area to record a captured image pair of x-y pixels having common features of the surface area; and
a processor coupled to the first and second cameras, the processor to execute instructions from a computer readable medium, the instructions to:
correlate the captured image pair using a fiducial to assist;
measure a set of disparity distances between the common features in the captured image pair; and
convert the set of disparity distances to a set of z-height measurements with a resolution incorporating the separation distance, the lens focal length, the set of disparity distance, and a calibration error factor.

6. The 3D printer of claim 5, wherein the computer readable medium further includes instructions to:
receive a first trigger signal from the 3D printer during a build session to create a first set of z-height measurements after deposition of a build material layer on the surface area; and
receive a second trigger signal from the 3D printer to create a second set of z-height measurements of a processed build material layer after irradiation of the build material with an energy source.

7. The 3D printer of claim 6, wherein the set of z-height measurements includes multiple layers of unprocessed build material layers and processed build material layers and the computer readable medium further includes instructions to allow a graphical user interface to view a topology of the set of z-height measurements for both the unprocessed build material layers and the processed build material layers.

8. The 3D printer of claim 6, wherein the computer readable medium further includes instructions to:
actively monitor the z-height measurements of the unprocessed build material layer and the processed build material layer;
determine an out-of-process condition for at least one of the unprocessed build material layer and the processed build material layer; and
alter the build session when the out-of-process condition is outside a predetermined threshold.

9. The 3D printer of claim 8, wherein the 3D printer includes a build bed with the surface area movable in a z axis and the computer readable medium further includes instructions to:
create a first set of z-height measurements of the surface area;
move the build bed by a predetermined z distance;
create a second set of z-height measurements of the surface area; and
determine a set of differences over the surface area between the first and second sets of z-height measurements;
compare the predetermined z distance to the set of differences over the surface area; and
determine the calibration error factor be at least one of a uniform error factor, a pixel by pixel error factor, and a formulated error factor based on pixel location within the surface area.

10. The 3D printer of claim 5, further comprising:
an enclosure around the surface area and wherein the first and second camera are positioned outside the enclosure and include complementary different polarized filters; and
the illumination source having multiple sources of complementary different polarized light sources positioned inside the enclosure and oriented around the surface area.

11. A non-transitory computer readable medium to perform surface height measurements, comprising instructions that when read and executed by a processor cause the processor to:
correlate a captured image pair having common features recorded from a first camera and a second camera spaced a separation distance, focused at a lens focal length to a surface area, and oriented at different angles to the surface area by using a fiducial to assist;
measure a set of x-y disparity distances between the common features in the captured image pair; and
convert the set of x-y disparity to a set of z-height measurements with a resolution incorporating the separation distance, the lens focal length, the set of x-y disparity distances, and a calibration error factor.

12. The non-transitory computer readable medium of claim 11 further comprising instructions to:
actively monitor the z-height measurements of both an unprocessed build material layer and a processed build material layer in the surface area; and
determine an out-of-process condition for at least one of the unprocessed build material layer and the processed build material layer.

13. The non-transitory computer readable medium of claim 12 wherein the out-of-process condition includes at least one of detecting a broad band of depressed build material across a span of the processed build material, detecting the unprocessed build material layer having build material accumulated on one side of the processed build material layer, and detecting a gouge parallel to a spread direction of the unprocessed build material layer over several layers.

14. The non-transitory computer readable medium of claim 12 further comprising instructions to create a graphical user interface to view a topology of multiple z-height measurements for both the unprocessed build material layer and the processed build material layer.

15. The non-transitory computer readable medium of claim 12 further comprising instructions to detect and map a particle size from multiple z-height measurements.
